(19) United States
(12) Patent Application Publication
(10) Pub. No.: US 2006/0018489 A1
(43) Pub. Date: Jan. 26, 2006

(54) Advanced digital vehicle microphone system and method having stop request chime capabilities

(75) Inventor: Philip P. Piazza, Plainview, NY (US)

Correspondence Address: DILWORTH & BARRESE, LLP, 333 EARLE OVINGTON BLVD., UNIONDALE, NY, 11553, US

(73) Assignee: Clever Devices, Syosset, NY (US)

(21) Appl. No.: 10/897,832

(22) Filed: Jul. 23, 2004

(51) Int. Cl. H04R 27/00; H04B 1/00

(52) U.S. Cl. 381/82; 381/86; 340/7.62

(57) ABSTRACT

Disclosed is a digital vehicle microphone system for recording and playback of announcements for use in a vehicle public address system having stop request chime capabilities, comprising a microphone apparatus for pre-recording at least one announcement, the apparatus having a microphone and record switch; a storage device for storing each announcement from the microphone apparatus and a delayed playback circuit for delayed playback of each announcement through the vehicle public address system; at least one input device for receiving a stop request; and means for generating an audible alert and outputting the audible alert via the public address system upon receipt of the stop request.

### BACKGROUND

1. Technical Field

The present disclosure relates to a digital vehicle microphone system for recording and announcing messages over public address systems in public transportation vehicles, and more particularly, to a digital vehicle microphone system that enables a stop request chime to be broadcast over the public address system.

2. Background of Related Art

Virtually all public transit buses are currently equipped with a stop request chime that allows passengers to notify the driver that they would like to get off at the next stop. This notice is generally accomplished by pressing or pulling one of a number of switches or pull-cords located throughout the vehicle. The switch or pull-cord is connected to a system that sounds an audible tone alert. The audible tone alert is then heard by the driver of the vehicle, wherein the driver can then stop at the next scheduled stop, otherwise, if no alert is made, the driver will pass the stop (as long as there are no persons waiting at the scheduled stop for pickup). The audible tone alert is also sounded in the main area of the vehicle to alert other passengers to the stop request, which prevents multiple stop requests from having to be made by the passengers.

The stop request chime system of the prior art is a self contained system. The system comprises a power supply, usually run off of the vehicle power system, a series of switches or pull-cords, an audible tone generator, and a controller. The controller can be a simple relay or a computer processor. The audible tone generator can be a speaker, bell or buzzer.

In addition to the stop request chime system, current modes of public transportation require the operator of the vehicle to make announcements to passengers pertaining to specific vehicle routes and upcoming stops. This is particularly seen in the use of bus and other similar public transportation vehicles. Until now, announcements made by an operator of a bus required the operator to reach over to a flexibly mounted-type microphone and pull it close to his or her mouth while simultaneously depressing a “push-to-talk” switch. This procedure had to be repeated over and again at each stop making it difficult for the operator to fully concentrate on driving the vehicle. Alternatively, some public transportation vehicles use a microphone system which are not well suited to such an environment which includes factors such as ambient and traffic noise levels, feedback and the like.

The duplication of the hardware and components of these two systems greatly adds to the cost of the public transportation system.

### SUMMARY

According to the present disclosure, the above and other problems are solved by providing a digital vehicle microphone system for recording and playback of announcements for use in a vehicle public address system having stop request chime capabilities, comprising a microphone apparatus for pre-recording at least one announcement, the apparatus having a microphone and record switch; a storage device for storing each announcement from the microphone apparatus and a delayed playback circuit for delayed playback of each announcement through the vehicle public address system; at least one input device for receiving a stop request; and means for generating an audible alert and outputting the audible alert via the public address system upon receipt of the stop request.

Also provided is a method of operating a stop request chime of a vehicle public address system, comprising the steps of receiving a stop request from an input device; generating an audible alert upon receipt of the stop request; and outputting the audible alert via the public address system.

### BRIEF DESCRIPTION OF THE DRAWINGS

The accompanying drawings, referred to herein and constituting a part hereof, illustrate the preferred embodiments of the apparatus of the present disclosure, and, together with the description serve to explain the principles of the present disclosure.

FIG. 1 is a block diagram illustrating a digital vehicle microphone system that is capable of providing a stop request chime to be broadcast over the public address system according to an embodiment of the present invention.

### DETAILED DESCRIPTION OF PREFERRED EMBODIMENTS

Hereinafter, preferred embodiments of the present invention will be described in detail with reference to the accompanying drawings. In the drawings, the same or similar elements are denoted by the same reference numerals even though they are depicted in different drawings. In the following description of the present invention, a detailed description of known functions and configurations incorporated herein will be omitted for clarity where they are well-known in the art.

U.S. Pat. No. 6,522,754 to Long et al., and assigned to common assignee herein, the contents of which are incorporated herein by reference, discloses a “hands free” announcement system that enables an operator of a vehicle to make announcements pertaining to the vehicle's upcoming stops and route information. The system provides “hands free” announcements of upcoming vehicle stops while eliminating the need for the operator to physically hold the microphone and pull it close to his/her mouth while trying to safely operate the vehicle. The system also automatically announces the vehicle's particular route information through an external speaker broadcast system upon the activation of the vehicle's exterior door. Additionally, the system employs a microphone sensitive enough to pick up the operator's voice from a distance where the operator remains in full control of the vehicle. In addition, the system eliminates feedback by pre-recording the operator's announcements and then replaying the announcements only after the operator has finished the recording process. Also, the system provides “hands free” radio communication between the operator and the vehicle dispatch headquarters. Further, the system is capable of being easily interfaced to existing public address systems already installed on public transportation vehicles. And, finally, the system is compactly provided in a rugged tamper-proof casing.

The present invention incorporates the stop request chime system into the hands-free announcement system. By so incorporating the two systems, the overall costs of the vehicle can be greatly reduced. In addition, the complexity and redundancy of the vehicle is reduced, thus reducing repair and associated down time for the vehicle.

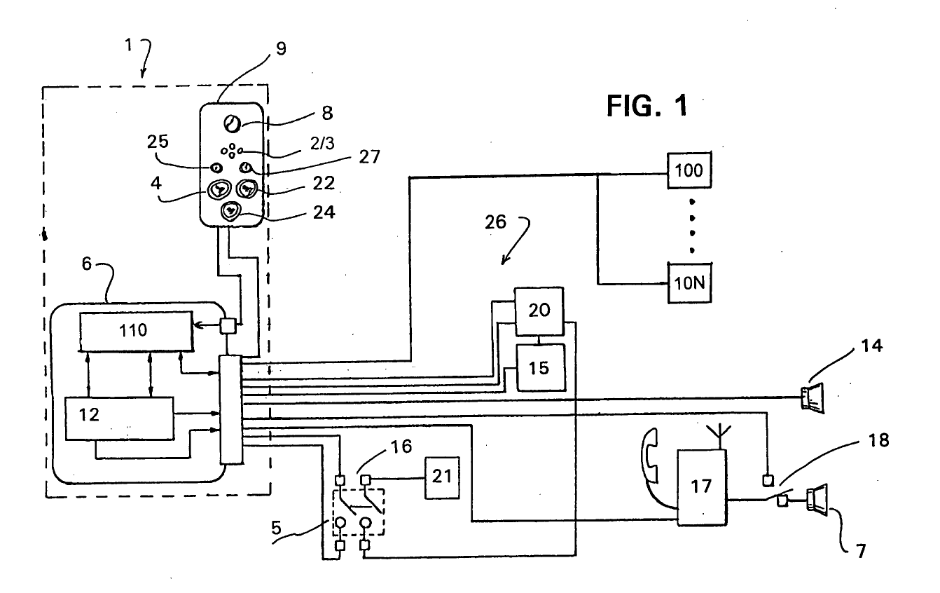

FIG. 1 is a block diagram illustrating a digital vehicle microphone system that is capable of providing a stop request chime to be broadcast over the public address system according to an embodiment of the present invention. The digital vehicle microphone system (DVMS) 1 of the present disclosure easily interfaces to existing public address (PA) systems 26 currently installed on public transportation vehicles. It can also be used in lieu of conventional PA systems. The stop request chime system adds input devices 100 to 10N to the DVMS 1. The input devices 100-10N can be, for example, push buttons, pull cords, etc. Also added to the DVMS 1 is a software subroutine, contained in processor 110, to output an audible alert when an input device 100-10N is activated. The audible alert is output via internal speaker 7. Processor 110 can control the speaker outputs and volume levels of the stop request chime system.

The DVMS 1 described herein includes a “hands free” microphone apparatus 2 having a highly sensitive condenser microphone 3, a push-to-record hand actuated record switch 4 and a dual color record mode light emitting diode (LED) 8. The microphone apparatus 2 also includes a mute switch 22 for disabling outside announcements made over the vehicles PA system 26 and a radio switch 24 for “hands free” communication between the operator and radio dispatch headquarters. The microphone apparatus 2 is electronically connected to a control circuit 6 which is capable of storing at least one pre-recorded announcement and then playback the announcement as needed by the operator of the vehicle or automatically when an external signal is triggered, i.e. opening the passenger door of the vehicle. In alternative embodiments, microphone apparatus 2 includes a mute switch indicator 25 and a radio mode indicator 27.

It is to be understood that the applicability of the DVMS 1 is not limited to only that of a bus type vehicle, but can also be implemented on similar vehicles such as trolleys, shuttle vans, water shuttles, and the like. The DVMS I is designed to easily interface to existing public address systems 26 currently installed on public transportation systems.

The microphone apparatus 2 can be mounted at a location that is out of the operator's line of sight and preferably at a level approximately equal to the level of the operator's head. A preferable mounting location of the microphone apparatus 2 is along a window frame of the bus. The mounting location of the microphone apparatus 2 is such that it does not impede or obstruct the operator's ability to safely drive the bus and such that allows the operator to pre-record announcements using a normal tone level while remaining seated in the operator's normal operating position, i.e. seated comfortably in the drivers seat. The highly sensitive condenser microphone 3 is designed to be sensitive enough to pick up the operator's voice without the need for the operator to shout or lean in towards the microphone 3. This enables the operator to make “hands free” announcements pertaining to the bus route information, upcoming bus stops and radio communication with dispatch headquarters.

The PA systems 26 installed on many public transportation vehicles includes both internal and external speakers for the announcing of upcoming stops and route information, respectively. As is shown in FIG. 1, the DVMS 1 of the present disclosure is interfaced with a bus public address system 26 which includes an internal speaker broadcast system 7 and an external speaker broadcast system 14. The external speaker broadcast system 14 is electrically connected to the control circuit 6. The external speaker system 14 is used to playback the pre-recorded bus route information when triggered by a specific signal such as the opening of the bus passenger door. Similarly, the internal speaker broadcast system 7 is also electrically connected to the control circuit 6. The internal speaker system 7 is used to playback the upcoming bus stop announcement once the operator of the bus has completed pre-recording the particular announcement. As stated earlier, the stop request chime is broadcast over either or both the internal speaker system 7 and the external speaker system 14.

As stated earlier, the DVMS 1 can, and is the preferred embodiment, be installed as a new installation. This embodiment does not require existing public address system 26. The DVMS 1 can directly drive the internal speaker broadcast system 7 and the external speaker system 14.

The DVMS 1 is capable of pre-recording two separate announcements, the first, an externally broadcast bus route announcement and, the second, an internally broadcast upcoming bus stop announcement. The bus route information is recorded using a push-to-record hand actuated record switch 4 that is located on an external face of DVMS1. The recording of upcoming bus stops is accomplished through the use of a foot actuated record switch 5 located at the operator's feet. The foot actuated record switch 5 is electronically coupled to the control circuit 6 and is powered by the vehicle's DC power source 20, i.e. battery, as is the entire DVMS 1. One less duplication of devices occurs since the stop request chime system will also be powered by DC power source 20, rather than requiring a separate power supply. The foot actuated record switch 5 is actuated by the operator's foot while he/she is driving thus leaving the operator's hands on the wheel and the operator in complete control of the vehicle at all times. Upon actuation of the foot actuated record switch 5, a signal is sent to the control circuit 6 to begin recording the upcoming stop information. Upon completion of the recording, the operator takes his/her foot off the foot actuated record switch 5 setting the record switch to its off position. The DVMS 1 through control circuit 6 then automatically begins playback of the pre-recorded upcoming bus stop announcement over the bus internal speaker broadcast system 7.

The microphone apparatus 2 consists primarily of a hand actuated record switch 4, a highly sensitive condenser microphone 3, a mute switch 22, a radio switch 24 and a dual color record indicator LED 8. In a preferred embodiment, the dual color record indicator LED 8 illuminates green upon recording of the internal message. Similarly, upon recording of the external message, the LED 8 illuminates red. The use of any other colors or color combinations with the DVMS 1 of the present disclosure is obviously contemplated.

The mute switch 22 is used to disable the playback of the bus route announcement through the external speaker system 14, once the mute switch 22 is actuated, LED 8 will flash red at 15 second intervals to remind the operator that the external speaker system 14 is disabled. A subsequent actuation of mute switch 22 will enable the external speaker system 14 back to normal PA conditions.

Radio switch 24 enables an operator to make “hands free” communications with the radio dispatch center in much the same manner as recording the internal and external messages. Actuation of radio switch 24 disables the internal 7 and external 14 speaker broadcast systems of the bus PA system 26 thereby allowing the operator to communicate through the microphone 3 and radio 17 and associated radio speaker system (not shown) without delay.

The microphone elements and switches of microphone apparatus 2 are preferably housed within a rugged, vandal and tamper resistant casing 9 approximately nine inches in height and three inches in width, although other dimensions are obviously contemplated and are within the scope of the present disclosure. The casing 9 is easily mounted to the vehicle by any number of known tamper resistant fasteners, such as a bolt, screws, rivets, bands and the like are contemplated. The microphone elements and/or casing 9 may also be remotely mounted throughout the vehicle.

The casing 9 is coupled to a flexible metal harness assembly and conduit (not shown) disposed therein. The conduit includes all the electrical leads associated with the features of the DVMS 1. Once harness assembly is coupled to casing 9, the conduit is electrically attached to the control circuit 6 of the microphone apparatus 2 via a plug-in type connector. The control circuit 6 is ideally located within casing 9 but may also be located on the floor of the bus or at any other location that does not obstruct the operator's ability to safely operate the bus. The control circuit 6 of DVMS 1 is physically manifested upon a printed circuit board (PCB), as is known in the art, and fixedly secured within casing 9.

DVMS 1 includes control circuit 6 (PCB) housed within outer casing 9 of microphone apparatus 2. Preferably, the control circuit 6 includes processor 110 and memory storage device 12 capable of storing the operator's announcements. The control circuit 6 also includes circuitry capable of delaying playback of each announcement until triggered by a specific signal. The memory storage device 12 is capable of storing announcements. It is also contemplated that the memory storage device 12 according to the present disclosure may include analog, magnetic tape digital circuitry or other known information storage devices. Announcements regarding the bus route and the upcoming bus stop information are stored in the memory storage device 12. It is important to note that although a specific design and layout has been described herein, the scope of the invention clearly encompasses alternative design and layout configurations.

An important feature of the DVMS 1 is its ability to eliminate feedback of the operator's announcements over the bus internal 7 and external 14 speaker broadcast system. To remedy any feedback problems, the control circuit 6 is designed to initially pre-record the operator's announcements, store the pre-recorded announcements in the memory storage device 12, and subsequently play back the announcements once the recording process is complete or when triggered by an outside signal.

According to the present embodiment, the operator pre-records the upcoming bus stop announcement into the memory storage device 12. Once the operator has finished pre-recording the message and has turned off the foot actuated record switch 5, by operation of removing his/her foot off the record switch 5, the announcement is subsequently broadcast through the bus internal speaker broadcast system 7. The pre-recording and subsequent playback of the announcement eliminates the possibility of feedback and provides for the clear and audible broadcast of the announcement. Similarly, the bus route information announcement is also pre-recorded. This announcement is stored in the memory storage device 12 and then played back through an external speaker broadcast system 14 upon actuation of an outside signal such as opening of the bus passenger door.

A door trigger relay signal 15 is used to trigger the memory storage device 12 of DVMS 1 to respond and playback the bus route announcement through external speaker system 14. The door trigger relay signal 15 is electrically connected to control circuit 6 and is tripped when the passenger door to the bus is opened. Once the door trigger relay signal 15 is tripped, the control circuit 6 automatically begins playback of the pre-recorded bus route information announcement over the bus external speaker broadcast system 14.

The fan-blower relay switch 16 and fan blower 21 are both electrically coupled to the foot actuated record switch 5 and the hand record switch 4. Record switches 4 and 5 are both electrically connected to the control circuit 6. Upon actuation of either the foot actuated record switch 5 or the hand actuated record switch 4, the fan-blower relay switch 16 disengages the bus fan-blower 21 thereby lowering the bus interior ambient noise level and enabling the operator to pre-record a clear announcement through the highly sensitive condenser microphone 3.

A two-way radio and handset 17, for example, a Motorola Spectra Radio Handset, is part of the bus PA system 26. As such, the radio 17 is also interfaced with the DVMS 1 of the present disclosure. The radio 17 is electronically connected to the control circuit 6 and to a radio bypass switch 18. The radio 17 is interfaced into DVMS 1 such that any incoming radio message has priority over an announcement concurrently being broadcast over the internal speaker broadcast system 7.

The DVMS 1 includes a radio switch 24 in microphone apparatus 2 which enables the operator to make “hands free” communications with dispatch headquarters in much the same manner as recording the internal and external messages, that is, having both hands on the steering wheel and remaining in full control of the vehicle. Once radio switch 24 is actuated, both the internal and external speaker systems of the bus PA system 26 are disabled leaving all radio 17 communications relayed through the microphone 3 and the radio's 17 own speaker system. While in the radio mode, LED 8 will continuously flash in both red and green colors, or can be supplied with a dedicated LED to indicate that the radio mode is activated. Subsequent actuation of the radio switch 24 returns the DVMS 1 back to normal PA mode.

The radio bypass switch 18 is electrically coupled to the two-way radio 17, the speaker broadcast system 7 and 14 and control circuit 6. The radio bypass switch 18 is used to automatically divert broadcast of any incoming radio message directly over to the internal speaker broadcast system 7, as well as, the radio 17 speaker system. The bypass switch 18 will also interrupt any announcement concurrently being broadcast by the control circuit 6, i.e. an upcoming bus stop announcement, in order to switch to the incoming radio message. This is done to insure that the operator of the vehicle immediately receives and is made immediately aware of any important information that is broadcast over the radio 17 from vehicle dispatch headquarters.

The present disclosure is specifically designed to be incorporated into a conventional PA system 26 of a public transportation vehicle such as a bus or other similar vehicle. The typical bus PA system 26 includes volume control switches for adjusting internal 7 and external 14 speaker system volume levels. Also included are internal/external switches electrically connected via an internal/external relay control signal (not shown) to the DVMS 1. The internal/external switches are primarily used for alternating the playback of internal and external recorded messages to the external and internal speaker systems, respectively. The internal/external relay control signal is a driver relay incorporated as part of the DVMS 1. This internal/external relay is used to communicate the actuation of the internal/external switches to the control circuit 6 to thereby instruct the control circuit 6 to playback the recorded messages. The DVMS 1 of the present disclosure also includes several optional driver relays and wiring harnesses that can be used for future optional functions relating to the PA system, driver controls and the like.

The operation of the stop request chime system will now be described in more detail with respect to FIG. 1. When a passenger desires to stop at an upcoming stop, the passenger activates on of the plurality of input devices 100-10N. Upon its activation, the input device 100-10N sends a signal to processor 110. When processor 110 receives the signal from input device 100-10N, processor 110 generates an audible alert signal. The audible alert signal is output from processor 110 and sent to either internal speaker system 7 or external speaker system 14, or both. The speaker system to which the audible alert signal is sent outputs the audible alert to notify the driver and other passengers that a stop request was made. The stop request chime system then resets and awaits another input signal.

It will be understood that various modifications can be made to the various embodiments of the present disclosure herein disclosed without departing from the spirit and scope thereof. Also, various modifications may be made in the configuration of the parts. Therefore the above description should not be construed as limiting the present disclosure but merely as exemplifications of preferred embodiments thereof. Those skilled in the art will envision other modifications within the scope and spirit of the present disclosure as defined by the claims appended hereto.

What is claimed is:

1. A digital vehicle microphone system for recording and playback of announcements for use in a vehicle public address system having stop request chime capabilities, comprising:
a microphone apparatus for pre-recording at least one announcement, the apparatus having a microphone and record switch;
a storage device for storing each announcement from the microphone apparatus and a delayed playback circuit for delayed playback of each announcement through the vehicle public address system;
at least one input device for receiving a stop request; and
means for generating an audible alert and outputting the audible alert via the public address system upon receipt of the stop request.

2. The system of claim 1, wherein the means for generating an audible alert is a processor.

3. An improvement in a vehicle public address system having a hand held foot activated microphone and speaker broadcast system, and having stop request chime capabilities, the improvement comprising:
a hands-free microphone apparatus for pre-recording announcements, the apparatus having a microphone, mute switch, radio mode switch, record switch and record indicator;
a means for storing the announcements from the microphone apparatus and a delayed playback circuit for delayed playback of the announcements through the vehicle public address system;
at least one input device for receiving a stop request; and
means for generating an audible alert and outputting the audible alert via the public address system upon receipt of the stop request.

4. A vehicle public address system to be used on a bus having stop request chime capabilities, the system comprising:
a speaker broadcast system for broadcasting announcements, the broadcast system having at least one internal speaker for broadcasting an upcoming bus stop announcement and at least one external speaker for broadcasting a bus route information announcement;
a hands-free microphone apparatus for digitally pre-recording at least two separate announcements, the apparatus having a microphone, a hand actuated record switch for recording the bus route information announcement, a foot actuated record switch for recording the upcoming bus stop announcement, a mute switch for disabling at least one of the broadcasts of the announcements, a radio mode switch for radio communication and a record indicator;
a digital means for storing the at least two announcements and a delayed playback circuit for delayed playback of the at least two announcements through the speaker broadcast system;
an open door trigger relay which initiates the playback of the bus route information announcement through the at least one external speaker upon opening of the bus door;
a fan blower relay for temporarily disengaging the bus fan blower during the pre-recording of the upcoming bus stop announcement;
a two-way radio for receiving and transmitting radio messages;
at least one input device for receiving a stop request; and
means for generating an audible alert and outputting the audible alert via the public address system upon receipt of the stop request.

5. A method of operating a stop request chime of a vehicle public address system, comprising the steps of:
receiving a stop request from an input device;
generating an audible alert upon receipt of the stop request; and
outputting the audible alert via the public address system.
